(19) United States
(12) Patent Application Publication
(10) Pub. No.: US 2010/0046644 A1
(43) Pub. Date: Feb. 25, 2010

(54) SUPERPOSITION CODING

(75) Inventor: Laurent S. Mazet, Paris (FR)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/194,179

(22) Filed: Aug. 19, 2008

(51) Int. Cl. H04L 27/28

(52) U.S. Cl. 375/260

(57) ABSTRACT

A transmitter and receiver communicate using a modified superposition coding scheme. The transmitter transits superposition symbols which include a near end symbol for a near receiver and a far end symbol for a far receiver. The transmitter modifies the near end symbol depending on the far end symbol prior to transmission. Specifically, the near end symbol may be mirrored around the real or imaginary axis. The near receiver generates mirrored superposition symbols by applying mirroring to each received superposition symbol around at least one of the real axis and the imaginary axis in response to the value of the received symbol. The mirroring may remove the uncertainty of the far end symbol value allowing a simpler decision for the near end symbol. The mirroring performed by the transmitter and the near receiver will negate each other for the near end symbol thereby allowing a simplified near end receiver operation.

### FIELD OF THE INVENTION

The invention relates to superposition coding and in particular, but not exclusively, to superposition coding for broadband access radio communication systems.

### BACKGROUND OF THE INVENTION

For radio communication systems, the noise and interference performance and the spectral efficiency are some of the most critical parameters for providing high performance and a high capacity.

For example in multi user communication systems, the interference between different users is typically the main limiting factor for the achievable system capacity. For example, for the next generation of broadband systems, it has been proposed to use Multiple Input Multiple Output (MIMO) schemes to reduce the interference performance. Examples of these systems include IEEE 802.16e (also known as WiMAX mobile), 3GPP Long Term Evolution (including Evolved Packet System) or 3GPP2 Ultra Mobile Broadband.

In such systems, there is no requirement for base stations to be coordinated and therefore users in neighboring cells will interfere with the transmissions within a given cell. Accordingly, the average throughput of a cell is typically limited by the achievable throughput for users near the edges of the cell.

A modulation scheme which has been found to be suitable for many multi-user systems is known as superposition coding. For example, the use of superposition coding for reliable transmission over a broadcast channel (a single source attempting to communicate information simultaneously to several receivers) was proposed and analyzed in the article “Broadcast channels” by Cover, T. M. IEEE Trans. on Information Theory, 1972; 18(1):2-14. In the article, it was demonstrated that superposition coding outperforms time-sharing techniques in term of throughput.

In superposition coding, data is simultaneously transmitted to two receivers. In particular, superposition data symbols are generated by combining data symbols for a near receiver and data symbols for a far receiver. The combination is typically by a simple addition of complex valued data symbols and can be represented by:

x=\sqrt{α}sₙ+\sqrt{1−α}s_{f}

where sₙ and s_{f} are respectively the symbol for the near receiver and for the far receiver, and α reflects the power level of the transmission to the far receiver relative to the near receiver (0<α<1).

FIG. 1 illustrates an example where QPSK symbols are used both for the near and far receiver symbols (i.e. for both sₙ and s_{f}). FIG. 1 illustrates the four possible constellation points for sₙ (as circles) and the four possible constellation points for s_{f} (as squares). FIG. 1 also illustrates the relative energy of these symbols (i.e. the weighting determined by α).

FIG. 2 illustrates the sixteen possible combined superposition symbol constellation points resulting from the combining of the constellation points of FIG. 1 as circles (the original constellation points for the far end are retained for clarity).

Typically, the value of α is relatively small and thus superposition coding provides for a transmission of a relatively powerful message to the far near with a piggy backed and less powerful message being sent to the near receiver.

The far receiver can apply a simple technique when receiving the superposition symbol. Basically, the far receiver can simply determine the quadrant of the received superposition symbol and determine the received data symbol (the estimated s_{f}) as the data symbol that corresponds to this quadrant. Thus, the far receiver may simply consider the contribution of the near symbol (sₙ) as noise and may apply a conventional QPSK receiver operation.

However, for the near receiver, the impact of the far symbol (s_{f}) is very substantial and the receiver operation must be amended to take this into account. Accordingly, the near receiver first decodes the far data symbol (s_{f}) and then subtracts it from the received symbol. It then proceeds to determine the near data symbol (sₙ ) from the compensated value. Thus, the near receiver applies a Successive Interference Cancellation (SIC) procedure to compensate for the presence of the far data symbol (s_{f}). Although this approach may provide good performance in many scenarios, it is also associated with some disadvantages. Specifically, it requires a complex receiver operation for the near receiver resulting in high complexity and high resource requirements. In particular, the need for a complete decoding and re-encoding of the data for the far receiver before the data for the near receiver can be decoded results in a substantial complexity increase for the receiver. This may further result in increased computational power which may increase the power consumption and reduce battery life for battery driven receivers.

Hence, an improved system using superposition coding would be advantageous and in particular a system allowing increased flexibility, reduced complexity, reduced power consumption, reduced computational resource usage, facilitated implementation and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a transmitter for transmitting data symbols to a plurality of receivers; the transmitter comprising: a first data source for providing a first set of data symbols for transmission to a first receiver of the plurality of receivers; a second data source for providing second set of data symbols for transmission to a second receiver of the plurality of receivers; a superposition coder for generating combined superposition symbols for the first and second receivers by for each combined superposition symbol merging a pair of data symbols comprising a first data symbol from the first set of data symbols and a second data symbol from the second set of data symbols; and a transmitter unit for transmitting the combined superposition symbol; wherein the superposition coder is arranged to generate each combined superposition symbol by: generating a modified first data symbol by modifying the first data symbol dependent on the second data symbol; and generating the combined superposition symbol by combining the second data symbol and the modified first data symbol.

According to another aspect of the invention there is provided a receiver for receiving data symbols; the receiver comprising: a receiver unit for receiving combined superposition symbols, each of the combined superposition symbols corresponding to a transmitted superposition symbol comprising a first modified data symbol for the receiver superposed on a second data symbol for a different receiver, the first modified data symbol corresponding to a first data symbol intended for the receiver with a potential axis mirroring that is dependent on the second data symbol; a mirroring processor for generating mirrored superposition symbols by applying mirroring of each combined superposition symbol around at least one of the real axis and the imaginary axis in response to the combined superposition symbol; a compensation processor for generating decoding data symbols by applying a compensation for the second data symbol to each mirrored superposition symbols, the compensation being independent of a data value of the second data symbol; and a symbol processor for generating a received first data symbol from each decoding data symbol.

The invention may provide improved performance and/or facilitate operation or implementation for a communication system using superposition coding/modulation. In particular, the invention may allow reduced complexity of a receiver. For example, it may allow a receiver receiving the weakest data symbol of a superposition coded data symbol to receive this data symbol without having to perform successive interference cancellation or first determining the stronger data symbol of the superposition coded data symbol.

Specifically, the operation of the transmitter may enable or improve the receiving of the first data symbols without having to first determining the second data symbols.

The combined superposition symbols may specifically correspond to a summation of a modified first data symbol and a second symbol.

According to another aspect of the invention there is provided a method of transmitting data symbols to a plurality of receivers, the method comprising: providing a first set of data symbols for transmission to a first receiver of the plurality of receivers; providing a second set of data symbols for transmission to a second receiver of the plurality of receivers; generating combined superposition symbols for the first and second receivers by for each combined superposition symbol merging a pair of data symbols comprising a first data symbol from the first set of data symbols and a second data symbol from the second set of data symbols; and transmitting the combined superposition symbols; wherein the generating of the combined superposition symbols comprises generating each combined superposition symbol by: generating a modified first data symbol by modifying the first data symbol dependent on the second data symbol; and generating the combined superposition symbol by combining the second data symbol and the modified first data symbol.

According to another aspect of the invention there is provided a method of receiving data symbols, the method comprising: receiving combined superposition symbols, each of the combined superposition symbols corresponding to a transmitted superposition symbol comprising a first modified data symbol for the receiver superposed on a second data symbol for a different receiver, the first modified data symbol corresponding to a first data symbol intended for the receiver with a potential axis mirroring that is dependent on the second data symbol; generating mirrored superposition symbols by applying mirroring of each combined superposition symbol around at least one of the real axis and the imaginary axis in response to the combined superposition symbol; generating decoding data symbols by applying a compensation for the second data symbol to each mirrored superposition symbols, the compensation being independent of a data value of the second data symbol; and generating a received first data symbol from each decoding data symbol.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of constellation diagrams for data symbols for a near receiver and a far receiver in accordance with prior art;

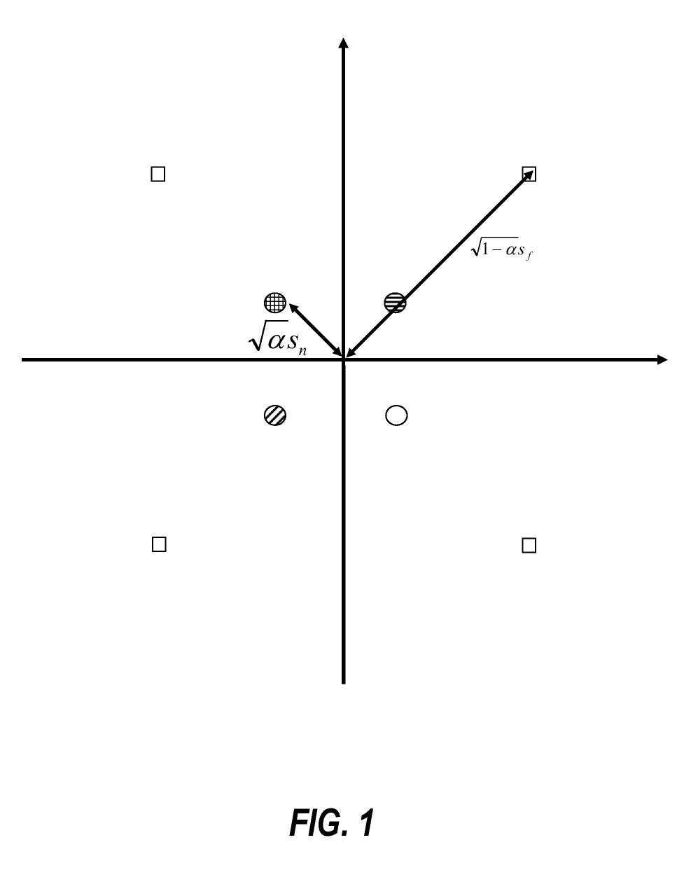

FIG. 2 is an illustration of constellation diagram for superposition symbols in accordance with prior art;

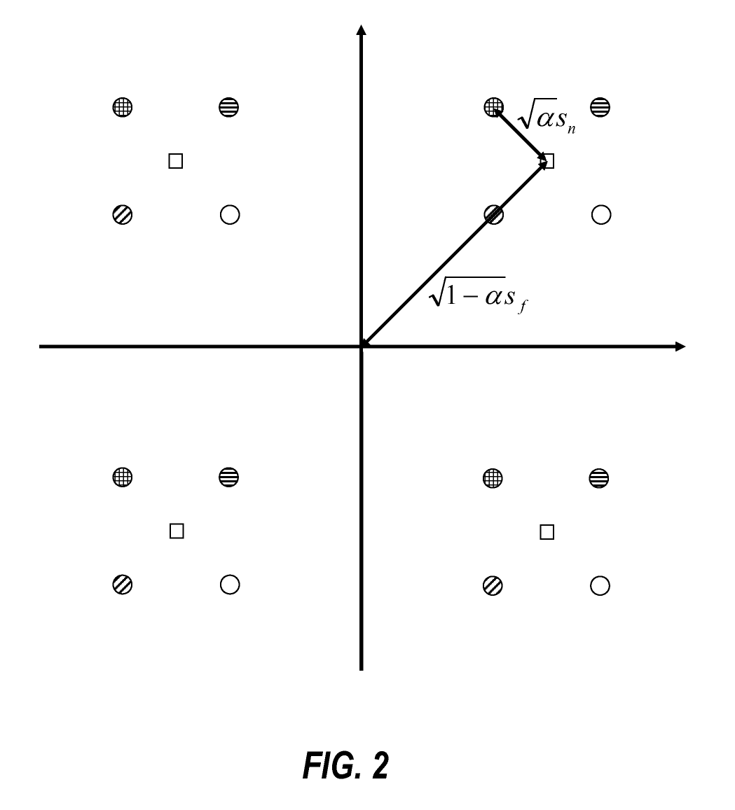

FIG. 3 illustrates an example of a communication system in accordance with some embodiments of the invention;

FIG. 4 illustrates an example of a transmitter in accordance with some embodiments of the invention;

FIG. 5 illustrates an example of a receiver in accordance with some embodiments of the invention;

FIG. 6 is an illustration of a constellation diagram for superposition symbols;

FIG. 7 is an illustration of a constellation diagram for superposition symbols in accordance with some embodiments of the invention;

FIG. 8 is an illustration of a constellation diagram for superposition symbols in accordance with some embodiments of the invention;

FIG. 9 is an illustration of a constellation diagram for a mirrored superposition symbol in accordance with some embodiments of the invention;

FIG. 10 is an illustration of a constellation diagram for a near end symbol in accordance with some embodiments of the invention;

FIG. 11 is an illustration of bit error rate performance for different communication schemes;

FIG. 12 illustrates an example of a method of transmitting data symbols to a plurality of receivers in accordance with some embodiments of the invention; and

FIG. 13 illustrates an example of a method of receiving data symbols in accordance with some embodiments of the invention.

### DETAILED DESCRIPTION OF SOME EMBODIMENTS OF THE INVENTION

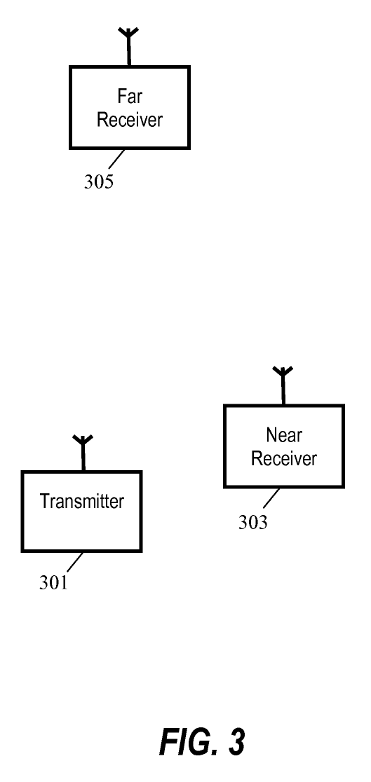

FIG. 3 illustrates an example of a communication system in accordance with some embodiments of the invention. In the example, the communication system comprises a transmitter 301 which is simultaneously transmitting data to a near receiver 303 and a far receiver 305 using superposition coding. The transmitter 301 may for example be a transmitter of a base station or an access point of a cellular communication system or a wireless network. The near receiver 303 and the far receiver may specifically be a remote station, subscriber unit, user equipment or terminal of the cellular communication system or the wireless network.

In the system, superposition data symbols are transmitted from the transmitter 301 to the near receiver 303 and the far receiver 305 with the data symbols for the near receiver 303 (henceforth the near end symbols) having lower energy than the data symbols for the far receiver 305 (henceforth the far end symbols). It will be appreciated that the management of the system will typically seek to ensure that the data is allocated such that the path loss to the near receiver 303 is lower than the path loss to the far receiver 305 (typically corresponding to the near receiver 303 being geographically closer to the transmitter 301 than the far receiver 305). However, this is not necessarily the situation in all possible scenarios and the terms near and far are merely used as convenient notation for referring to the two receivers and the two sets of data symbols being combined in the superposition data symbols. Thus, the transmitted superposition symbols are specifically given by:

x=\sqrt{α}sₙ+\sqrt{1−α}s_{f}

where sₙ and s_{f} are respectively the symbol for the near receiver 303 and the far receiver 305 and α reflects the power level of the transmission to the far receiver relative to the near receiver with 0<α<0.5 (i.e. the symbol energy for the far receiver symbols s_{f} is higher than for the near receiver symbols sₙ).

The following description focuses on embodiments of the invention wherein QPSK data symbols are used for both data symbols for the near receiver 303 and data symbols for the far receiver 305. Thus, both the near end symbols and the far end symbols are in the specific example QPSK symbols. However, it will be appreciated that in other embodiments other modulation schemes and constellation points may be used.

In the system of FIG. 3, the superposition encoding is modified at the transmitter 301 such that it allows a simplified receiver operation at the near receiver 303. Specifically, the encoding of the transmitter 301 is modified such that the near end symbols can be received without applying successive interference cancellation and without estimating the far end symbols.

Specifically, the transmitter 301 is arranged to modify the near end symbol dependent on the far end symbol prior to these being combined into the superposition symbol that is transmitted. The modification specifically comprises a mirroring of the near end data symbols around either the real or imaginary axis dependent on the quadrant in which the corresponding far end symbol is located. Thus, in the specific approach, the QPSK near end symbol is flipped dependent on the QPSK far end symbol.

Specifically, the modification to the near end symbol prior to the combination is such that it compensates or negates any corresponding impact on the near end symbol which results from a simplified operation that removes the uncertainty of the data value of the far end symbol. Specifically, the near receiver 303 may fold/mirror the received data symbol such that all constellation points for the far end symbol will end up in the same location. Thus, regardless of the actual data value of the far end symbol, the folding around the real and imaginary axis as appropriate will result in the received symbol always being in e.g. the first quadrant. Furthermore, due to the symmetric QPSK modulation, this will result in the component of the received symbol that is due to the far end symbol corresponding to the same location in the first quadrant regardless of the actual data value. Accordingly, this component may be removed resulting in a symbol value that corresponds to only the component from the near end symbol (and a noise component).

Thus, the pre-flipping performed at the transmitter compensates for the flipping introduced to the near end symbol by the folding performed by the receiver. Accordingly, the four QPSK constellation points for the near end symbol end up in the same constellation points regardless of the actual value of the far end symbol and thus the data value of the near end symbol can be made by a simple QPSK symbol decision.

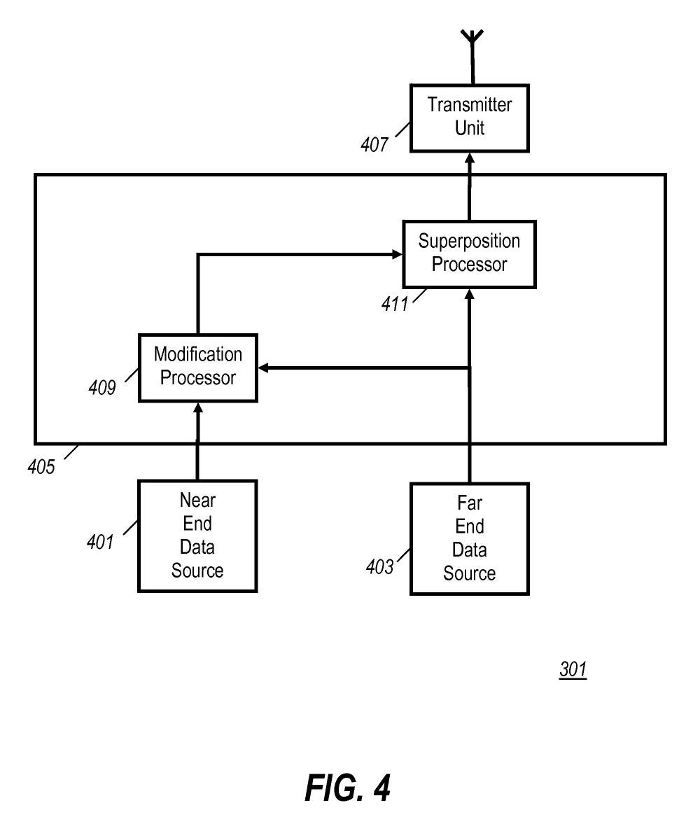

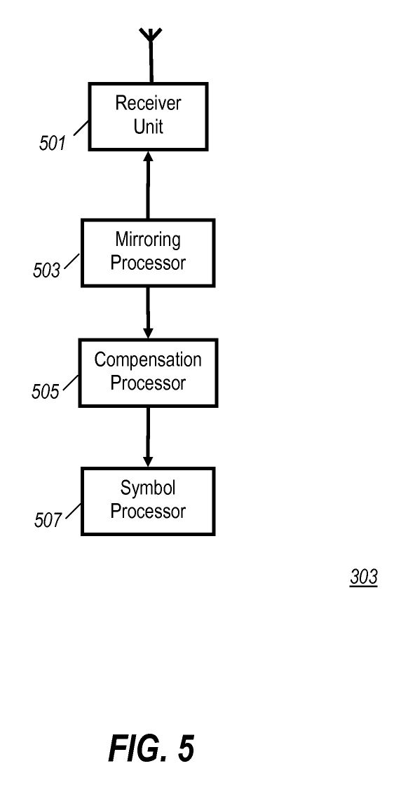

The approach will be described in more detail with reference to FIG. 4 which illustrates an example of elements of the transmitter 301 and FIG. 5 which illustrates an example of elements of the near receiver 303.

The transmitter 301 comprises a near end data source 401 which provides the data symbols that are to be transmitted to the near receiver 303. In the example, the data symbols are QPSK symbols.

The transmitter 301 furthermore includes a far end data source 403 which provides the data symbols that are to be transmitted to the far receiver 305. In the example, the data symbols are QPSK symbols.

The data symbols for the near receiver 303 and the far receiver 305 are fed to a superposition coder 405 which generates the combined superposition symbols for the two receivers 303, 305.

The superposition coder 405 is coupled to a transmitter unit 407 which is arranged to transmit the combined superposition symbols. Specifically, the transmitter unit 407 is arranged to perform quadrature modulation, upconversion, filtering and amplification etc as will be well known to the skilled person. The transmitter unit 407 is in the example power controlled such that the transmitted signal is received with a desired signal to noise ratio at the near receiver 303 and the far receiver 305.

The superposition coder 405 comprises a modification processor 409 which is coupled to the near end data source 401 and the far end data source 403. The modification processor 409 receives the two data symbols (i.e. the near end symbol sₙ and the far end symbol s_{f} respectively) that are to be combined into a superposition symbol. It then proceeds to modify the near end symbol dependent on the far end symbol.

Specifically, the modification is such that it negates any folding of the near end symbol that results from mirroring performed by the near receiver 303. As will be described, the near receiver 303 of the example will convert all received superposition symbols to the first quadrant by performing a folding/mirroring around the real axis and the imaginary axis as appropriate. However, this will also result in a mirroring of the constellation diagram for the near end symbols. For example, a folding/mirroring around the imaginary axis of the received superposition symbol will result in a mirroring around the imaginary axis of the near end symbol constellation diagram. In the transmitter 301 of FIG. 3, the modification processor 409 negates this mirroring by performing a pre-mirroring of the near end symbol constellation diagram before the near end symbol is combined with the far end symbol to generate the superposition symbol that is sent.

Specifically, the near end data symbol is mirrored around either the real axis or the imaginary axis depending on the value of the far end symbol it is to be combined with.

In the specific example, the near end symbol is mirrored around the real axis if a sign of an imaginary value of the far end symbol meets a criterion and otherwise it will not be mirrored around the real axis. It will be appreciated that the specific criterion may be dependent on the exact operation and mirroring that will be performed by the near receiver 303. However, in the specific example, the modification processor 409 is arranged to mirror the near end symbol around the real axis if the sign of the imaginary value of the far end symbol is negative and to not mirror the near end symbol around the real axis if the sign of the imaginary value of the far end symbol is positive.

Similarly, the near end symbol is mirrored around the imaginary axis if a sign of a real value of the far end symbol meets a criterion and otherwise it will not be mirrored around the imaginary axis. It will be appreciated that the specific criterion may be dependent on the exact operation and mirroring that will be performed by the near receiver 303. However, in the specific example, the modification processor 409 is arranged to mirror the near end symbol around the imaginary axis if the sign of the real value of the far end symbol is negative and to not mirror the near end symbol around the imaginary axis if the sign of the real value of the far end symbol is positive.

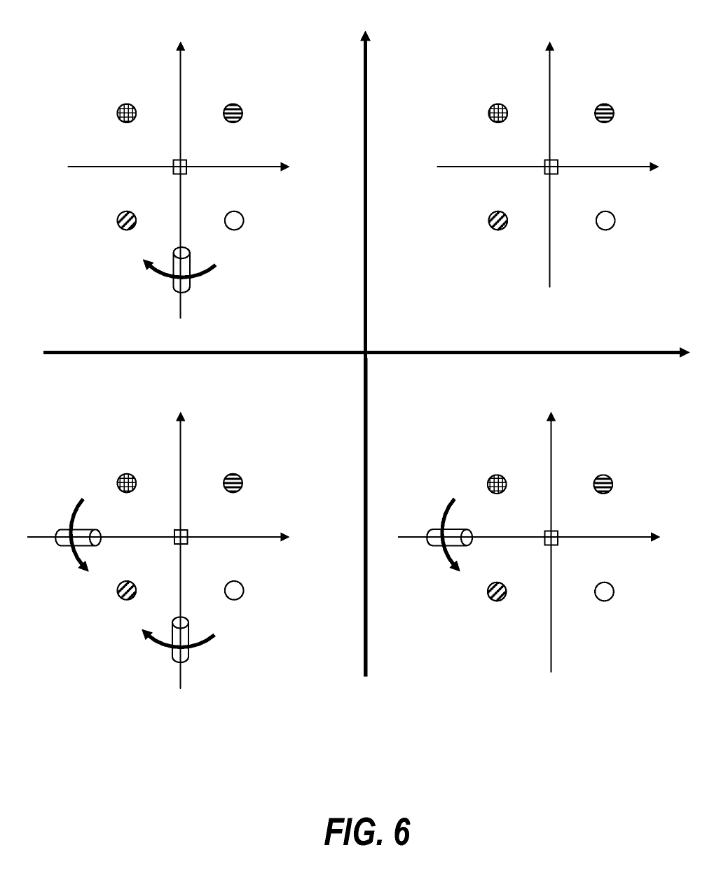

Thus, as illustrated in FIG. 6, the modification processor 409 may perform axis mirroring for the near end symbol constellation around the imaginary axis, if the far end symbol is in the second or third quadrant (i.e. if the real value is negative) and may perform axis mirroring for the near end symbol constellation around the real axis, if the far end symbol is in the third or fourth quadrant (i.e. if the imaginary value is negative).

The superposition coder 405 furthermore comprises a superposition processor 411 which is coupled to the modification processor 409 and the far end data source 403. The superposition processor 411 receives the modified near end symbol and the far end symbol and combines these into the superposition symbol which is transmitted by the transmitter unit 407.

Specifically, the superposition processor 411 can generated the superposition symbol by a weighted summation of the modified near symbol and the far end symbols. The weighting of the symbols may correspond to the relative power between the near end and far end transmitted symbols.

Specifically, the superposition processor 411 may generate the superposition symbols as:

x=\sqrt{α}s_{m,n}+\sqrt{1−α}s_{f}

where s_{m,n} is the modified near end symbol, s_{f} is the far end symbol and α reflects the power level of the transmission to the far receiver relative to the near receiver (0<α<1).

Specifically, the superposition symbol can be determined as

x=\sqrt{α}f(sₙ,s_{f})+\sqrt{1−α}s_{f}

where f(s,r)=sig( [symbol] (r)) [symbol] (s)+i×sig(ℑ(r))ℑ(s) represents the operation performed by the modification processor 409 and sig(.) is a function returning 1 for positive value and −1 for negative value.

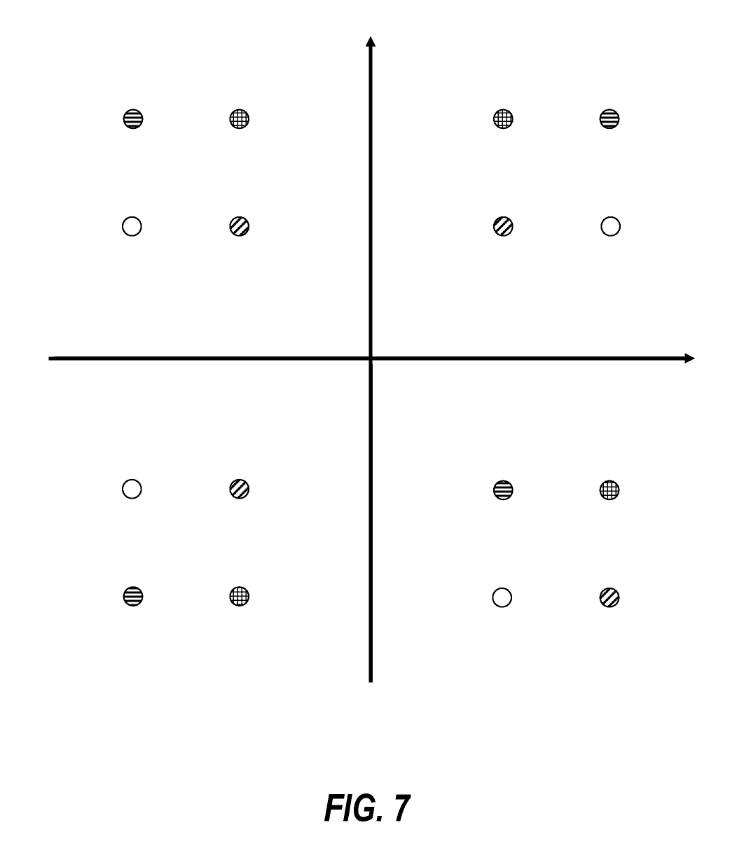

Thus, the superposition coder 405 generates the constellation points illustrated in FIG. 7.

The near receiver 303 comprises a receiver unit 501 which receives the transmitted signal and generates a received superposition symbol. Thus, the receiver unit 501 comprises functionality for filtering, amplifying, matched filtering, down-converting to complex base band etc as will be well known to the person skilled in the art.

The received superposition signal corresponds to the transmitted symbol but typically with added noise and interference. Thus, the received superposition symbol comprises a component due to the near end symbol, a component due to the far end symbol and a component that represents noise (including interference and distortion etc). However, in contrast to a conventional superposition symbol, the received superposition symbol comprises a component for the near end symbol which has been modified as described for the transmitter 301 of FIG. 4. Thus, the component corresponds to a near end symbol which may potentially have been modified by an axis mirroring.

The receiver unit 501 is coupled to a mirroring processor 503 which is arranged to generate a mirrored superposition symbol from each received superposition symbol by applying an axis mirroring to the received superposition symbol which depends on the value of the received superposition symbol.

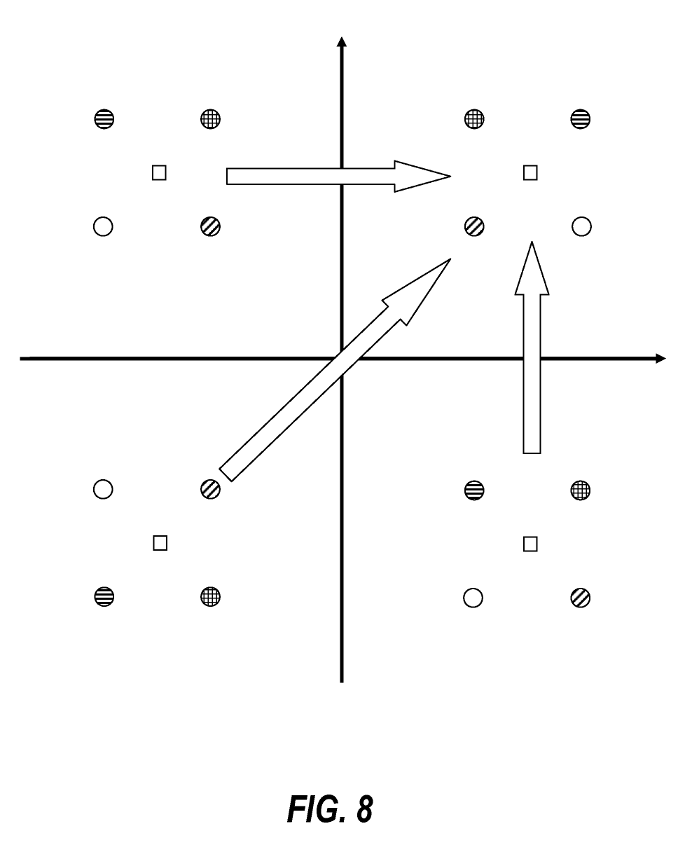

Specifically, the mirroring processor 503 is arranged to apply axis mirroring (folding) such that the received superposition symbol is moved into the first quadrant. Thus, as illustrated in FIG. 8, which shows the possible received constellation points (and the corresponding locations of the contribution for the far end symbol) in the absence of noise, a received superposition symbol in the second quadrant is mirrored around the imaginary axis, a received superposition symbol in the fourth quadrant is mirrored around the real axis, and a received superposition symbol in the third quadrant is mirrored around both the real and the imaginary axis.

Thus, in the example, the received superposition symbol is mirrored around the real axis if a sign of an imaginary value of the received superposition symbol meets a criterion and otherwise it is not be mirrored around the real axis. Specifically, the mirroring processor 409 is arranged to mirror the received superposition symbol around the real axis if the sign of the imaginary value of the received superposition symbol is negative and to not mirror the near received superposition symbol around the real axis if the sign of the imaginary value of the received superposition symbol is positive.

Similarly, in the example, the received superposition symbol is mirrored around the imaginary axis if a sign of a real value of the received superposition symbol meets a criterion and otherwise it is not be mirrored around the imaginary axis. Specifically, the mirroring processor 409 is arranged to mirror the received superposition symbol around the imaginary axis if the sign of the real value of the received superposition symbol is negative and to not mirror the received superposition symbol around the imaginary axis if the sign of the real value of the received superposition symbol is positive.

It will be appreciated that this mirroring may simply be achieved by the mirroring processor 503 taking the absolute value of both the real and the imaginary value of the received superposition signal.

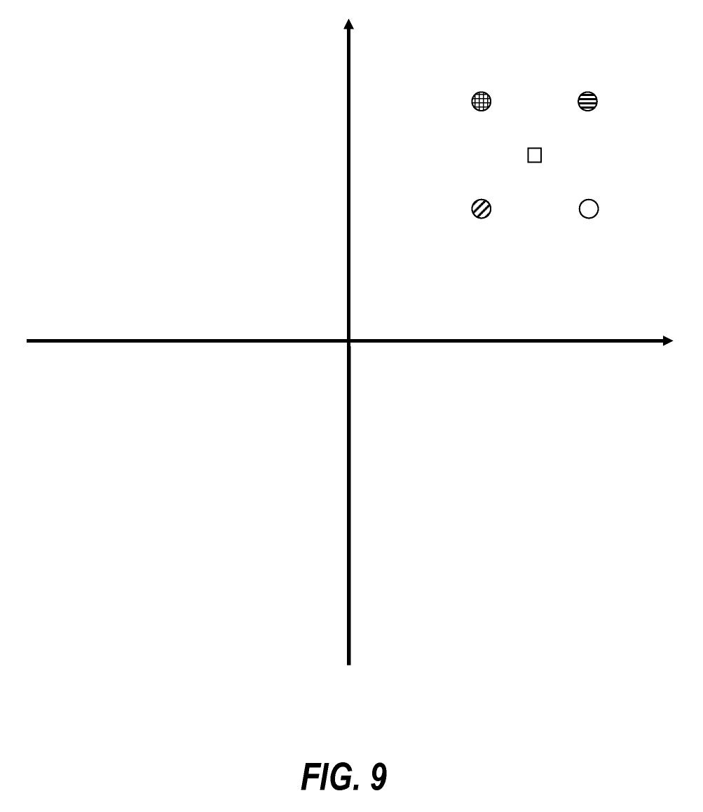

Thus, as illustrated in FIG. 9, the mirroring performed by the mirroring processor 503 will result in modified near end symbol being mirrored into the original near end symbol. Thus, specifically, the mirroring by the mirroring processor 503 of the component of the received superposition symbol that corresponds to the near end symbol is negated by the modification and the mirroring that is performed by the modification processor 409 of the transmitter 301.

Furthermore, the mirroring performed by the mirroring processor 503 results in all the constellation points of the far end symbol ending up in exactly the same position. Thus, the mirroring removes the uncertainty of the QPSK data value that is transmitted to the far receiver 305. As a consequence, the component of the received superposition symbol that corresponds to the far end symbol can be compensated for without it being necessary to determine the data value of the far end symbol and thus without performing the complex operation associated therewith and without having to perform successive interference cancellation.

Specifically, the mirroring processor 503 is coupled to a compensation processor 507 which generates decoding data symbols by applying a compensation for the far end symbol to each received mirrored superposition symbol. As the mirrored superposition symbol is independent of the data value of the far end symbol, the compensation can also be independent of the data value and thus the same compensation can be applied to all mirrored superposition symbols.

Specifically, the compensation processor 505 can compensate each mirrored superposition symbol by a value that corresponds to the single constellation point that all constellation points of the far end symbol results in after the processing by the mirroring processor 503.

Specifically, the compensation processor can subtract a compensating value which corresponds to the single QPSK constellation point for the far end symbol (i.e. to (1,1) in the specific example. The constellation point may be scaled dependent on an energy estimate for the far end symbols. For example, an averaged amplitude for the mirrored superposition symbols may be determined and the compensation value of (1,1) may be scaled to have the same amplitude.

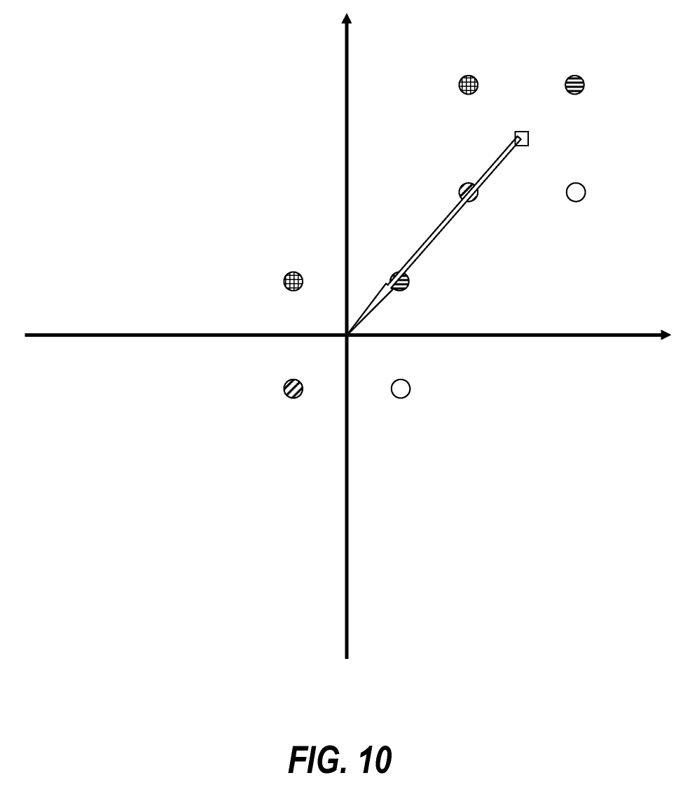

Thus, in the noiseless case as illustrated in FIG. 10, the component resulting from the far end symbol may be removed resulting in a constellation diagram for the decoding data symbols which is centered around the real and imaginary axes.

The compensation processor 505 is coupled to a symbol processor 507 which then proceeds to generate a received near end symbol from the decoding data symbol. Specifically, the symbol processor 507 can perform a simple standard QPSK symbol decision by determining the quadrant in which the decoding data symbol is located.

Thus, in the described system, a pre-mirroring is performed by the transmitter 301 thereby allowing a very simple receiver operation for the near end receiver 303. Thus, a substantial reduction in the complexity and computational resource requirement can be achieved.

Furthermore, the performance degradation relative to a full successive interference cancellation approach is very small and the approach may even provide improved error performance in some scenarios.

Specifically, for un-coded modulation, the approach can provide extra protection for situations wherein noise and interference will result in an erroneous determination of the far end symbol when using successive interference cancellation. Indeed, for these situations, the folding may still result in the constellation point being folded to the first quadrant.

Furthermore, in many scenarios it has been found that the use of a reduced complexity receiver provides a very small error rate performance degradation and in many situations the degradation is less than 0.1 dB.

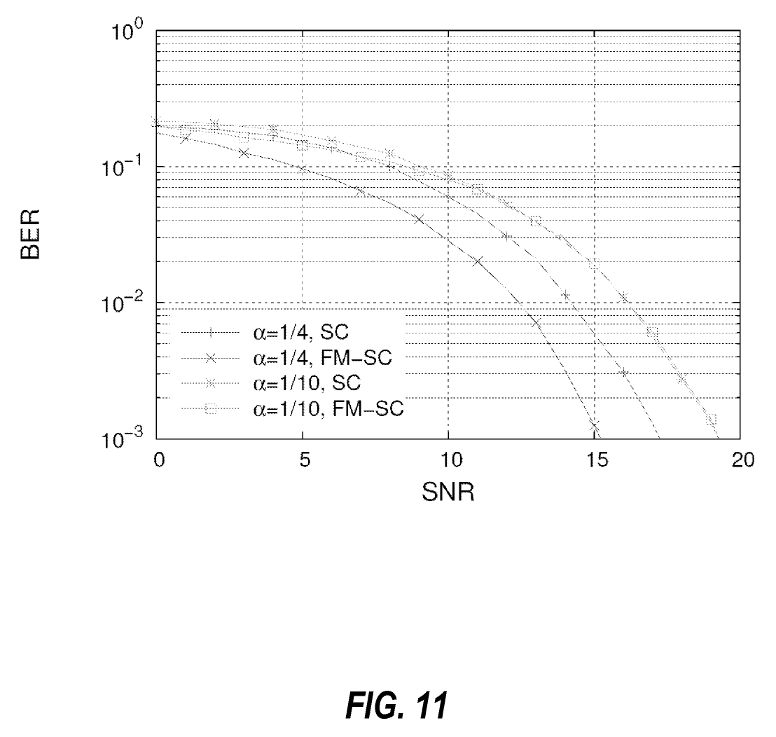

In more detail, FIG. 11 illustrates the bit error rate performance for the near receiver as a function of the signal to noise ratio. FIG. 11 specifically shows the performance for different power ratios (α equal to 0.25 and 0.1 respectively) for a conventional superposition coding scheme using successive interference cancellation (referenced by ‘SC+SIC’), for a superposition coding scheme as described with references to FIGS. 3-5 (referenced by ‘FM-SC’ for Flipped Modulation-Superposition Coding), and for this superposition scheme used with a receiver using successive interference cancellation (referenced by ‘FM-SC+SIC’).

It will be appreciated that the described approach may be used in many different radio communication systems. For example, it may be used in the next generation of broadband wireless systems, such as the IEEE802.16m communication system being standardized by the Institute of Electronic and Electric Engineers.

It will also be appreciated that although the described example focuses on QPSK data symbols for both the near and the far receiver, other modulation formats may be used in other embodiments.

For example, in other embodiments other orders of Quadrature Amplitude Modulation (QAM) may be used. For example, the near and/or the far end symbols may be Binary Phase Shift Key (BPSK) symbols. In such embodiments, the folding by the near receiver and/or the flipping by the transmitter may only be performed around one axis (e.g. the imaginary axis).

In many embodiments, the near end symbols are selected from constellation points which are symmetric around at least one of a real and an imaginary axis. This specifically allows the mirroring performed at the transmitter and the near receiver to result in the constellation points being mirrored to the same locations.

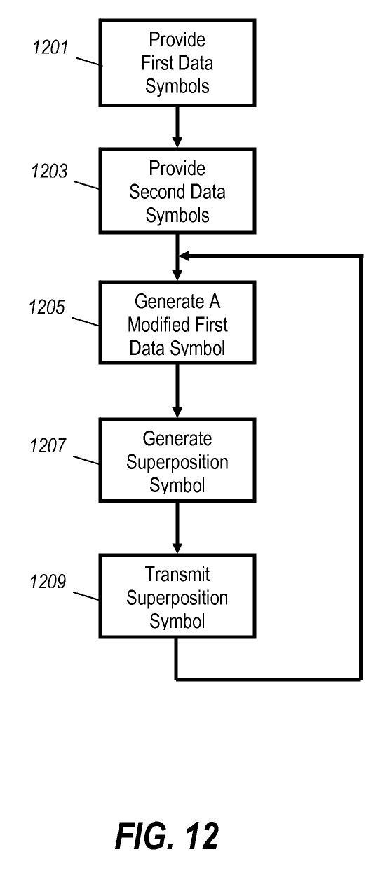

FIG. 12 illustrates an example of a method of transmitting data symbols to a plurality of receivers in accordance with some embodiments of the invention.

The method initiates in step 1201 wherein a first set of data symbols is provided for transmission to a first receiver of the plurality of receivers.

Step 1201 is followed by step 1203 wherein a second set of data symbols is provided for transmission to a second receiver of the plurality of receivers.

Step 1203 is then followed by steps 1205 and 1207 wherein combined superposition symbols are generated for the first and second receivers by, for each combined superposition symbol, merging a pair of data symbols comprising a first data symbol from the first set of data symbols and a second data symbol from the second set of data symbols.

Specifically, step 1205 comprises generating a modified first data symbol by modifying the first data symbol dependent on the second data symbol and step 1207 comprises generating the combined superposition symbol by combining the second data symbol and the modified first data symbol.

Step 1207 is followed by step 1209 wherein the combined superposition symbol is transmitted.

The method then returns to step 1205 to process the next symbol pair.

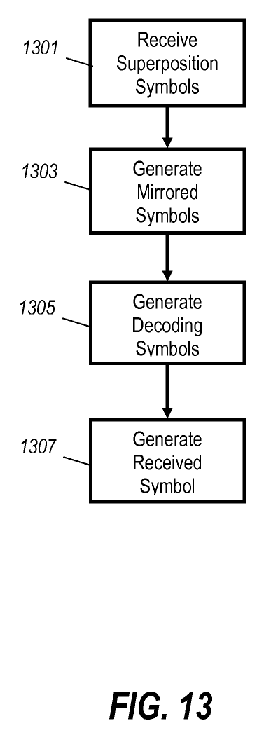

FIG. 13 illustrates an example of a method of receiving data symbols in accordance with some embodiments of the invention.

The method starts in step 1301 wherein combined superposition symbols are received. Each of the combined superposition symbols corresponds to a transmitted superposition symbol comprising a first modified data symbol for the receiver superposed on a second data symbol for a different receiver. The first modified data symbol corresponds to a first data symbol intended for the receiver with a potential axis mirroring that is dependent on the second data symbol.

Step 1301 is followed by step 1303 wherein mirrored superposition symbols are generated by applying mirroring of each combined superposition symbol around at least one of the real axis and the imaginary axis in response to the combined superposition symbol.

Step 1303 is followed by step 1305 wherein decoding data symbols are generated by applying a compensation for the second data symbol to each mirrored superposition symbol. The compensation is independent of the data value of the second data symbol.

Step 1305 is followed by step 1307 wherein a received first data symbol is generated from each decoding data symbol.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor.

Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A transmitter for transmitting data symbols to a plurality of receivers; the transmitter comprising:
a first data source for providing a first set of data symbols for transmission to a first receiver of the plurality of receivers;
a second data source for providing second set of data symbols for transmission to a second receiver of the plurality of receivers;
a superposition coder for generating combined superposition symbols for the first and second receivers by for each combined superposition symbol merging a pair of data symbols comprising a first data symbol from the first set of data symbols and a second data symbol from the second set of data symbols; and
a transmitter unit for transmitting the combined superposition symbol;
wherein the superposition coder is arranged to generate each combined superposition symbol by:
generating a modified first data symbol by modifying the first data symbol dependent on the second data symbol; and
generating the combined superposition symbol by combining the second data symbol and the modified first data symbol.

2. The transmitter of claim 1 wherein the superposition coder is arranged to generate the modified first data symbol by applying an axis mirroring of the first data symbol which is dependent on the second data symbol.

3. The transmitter of claim 2 wherein the axis mirroring is such that an axis mirroring of the combined superposition symbol to a given quadrant of the constellation space results in the modified first data symbol being mirrored to the first data symbol.

4. The transmitter of claim 2 wherein the superposition coder is arranged to perform a mirroring around a real axis if a sign of an imaginary value of the second data symbol meets a criterion.

5. The transmitter of claim 4 wherein the superposition coder is arranged to not perform the mirroring around the real axis if the sign of the imaginary value of the second data symbol does not meet the criterion.

6. The transmitter of claim 2 wherein the superposition coder is arranged to perform a mirroring around an imaginary axis if a sign of a real value of the second data symbol meets a criterion.

7. The transmitter of claim 6 wherein the superposition coder is arranged to not perform the mirroring around the imaginary axis if the sign of the real value of the second data symbol does not meet the criterion.

8. The transmitter of claim 1 wherein constellation points for the set of first data symbols are symmetric around at least one of a real and an imaginary axis.

9. The transmitter of claim 1 wherein the set of first data symbols comprises at least one of Quaternary Phase Shift Keying, QPSK, symbols and Quadrature Amplitude Modulation symbols.

10. The transmitter of claim 1 wherein the set of second data symbols comprises at least one of Quaternary Phase Shift Keying, QPSK, symbols and Binary Phase Shift Keying, BPSK, symbols.

11. A receiver for receiving data symbols; the receiver comprising:
a receiver unit for receiving combined superposition symbols, each of the combined superposition symbols corresponding to a transmitted superposition symbol comprising a first modified data symbol for the receiver superposed on a second data symbol for a different receiver, the first modified data symbol corresponding to a first data symbol intended for the receiver with a potential axis mirroring that is dependent on the second data symbol;
a mirroring processor for generating mirrored superposition symbols by applying mirroring of each combined superposition symbol around at least one of the real axis and the imaginary axis in response to the combined superposition symbol;
a compensation processor for generating decoding data symbols by applying a compensation for the second data symbol to each mirrored superposition symbols, the compensation being independent of a data value of the second data symbol; and
a symbol processor for generating a received first data symbol from each decoding data symbol.

12. The receiver of claim 11 wherein the mirroring processor is arranged to apply the mirroring such that the first modified data symbol is mirrored into the first data symbol.

13. The receiver of claim 11 wherein the mirroring processor is arranged to apply the mirroring such that all possible constellation points of the second data symbol are mirrored to a same constellation point.

14. The receiver of claim 13 wherein the compensation processor is arranged to generate the decoding data symbols by compensating each mirrored superposition symbols by a value corresponding to the same constellation point.

15. The receiver of claim 11 wherein the mirroring processor is arranged to perform a mirroring around the real axis if a sign of an imaginary value of the combined superposition symbol meets a criterion.

16. The receiver of claim 11 wherein the mirroring processor is arranged to perform a mirroring around the imaginary axis if a sign of a real value of the combined superposition symbol meets a criterion.

17. The receiver of claim 11 wherein the compensation processor is arranged to generate the decoding data symbols by subtracting a compensation value from each mirrored superposition symbols; the compensation value varying only in response to an energy estimate for the second data symbols.

18. A method of transmitting data symbols to a plurality of receivers; the method comprising:
providing a first set of data symbols for transmission to a first receiver of the plurality of receivers;
providing a second set of data symbols for transmission to a second receiver of the plurality of receivers;
generating combined superposition symbols for the first and second receivers by for each combined superposition symbol merging a pair of data symbols comprising a first data symbol from the first set of data symbols and a second data symbol from the second set of data symbols; and
transmitting the combined superposition symbols; wherein the generating of the combined superposition symbols comprises generating each combined superposition symbol by:
generating a modified first data symbol by modifying the first data symbol dependent on the second data symbol; and
generating the combined superposition symbol by combining the second data symbol and the modified first data symbol.

19. A method of receiving data symbols, the method comprising:
receiving combined superposition symbols, each of the combined superposition symbols corresponding to a transmitted superposition symbol comprising a first modified data symbol for the receiver superposed on a second data symbol for a different receiver, the first modified data symbol corresponding to a first data symbol intended for the receiver with a potential axis mirroring that is dependent on the second data symbol;
generating mirrored superposition symbols by applying mirroring of each combined superposition symbol around at least one of the real axis and the imaginary axis in response to the combined superposition symbol;
generating decoding data symbols by applying a compensation for the second data symbol to each mirrored superposition symbols, the compensation being independent of a data value of the second data symbol; and
generating a received first data symbol from each decoding data symbol.
